(19) United States
(12) Patent Application Publication
(10) Pub. No.: US 2015/0067833 A1
(43) Pub. Date: Mar. 5, 2015

(54) AUTOMATIC PHISHING EMAIL DETECTION BASED ON NATURAL LANGUAGE PROCESSING TECHNIQUES

(71) Applicants: Narasimha Shashidhar, The Woodlands, TX (US); Nabil Hossain, Houston, TX (US); Rakesh Verma, Houston, TX (US)

(72) Inventors: Rakesh Verma, Sugar Land, TX (US); Narasimha Karpoor Shashidhar, The Woodlands, TX (US); Nabil Hossain, Houston, TX (US)

(21) Appl. No.: 14/015,524

(22) Filed: Aug. 30, 2013

(51) Int. Cl. H04L 29/06

(52) U.S. Cl. CPC H04L 63/1483; H04L 63/30
USPC 726/22

(57) ABSTRACT

A comprehensive scheme to detect phishing emails using features that are invariant and fundamentally characterize phishing. Multiple embodiments are described herein based on combinations of text analysis, header analysis, and link analysis, and these embodiments operate between a user's mail transfer agent (MTA) and mail user agent (MUA). The inventive embodiment, PhishNet-NLP™, utilizes natural language techniques along with all information present in an email, namely the header, links, and text in the body. The inventive embodiment, PhishSnag™, uses information extracted form the embedded links in the email and the email headers to detect phishing. The inventive embodiment, Phish-Sem™ uses natural language processing and statistical analysis on the body of labeled phishing and non-phishing emails to design four variants of an email-body-text only classifier. The inventive scheme is designed to detect phishing at the email level.

### PRIOR APPLICATION

Provisional application filed on Aug. 21, 2012, Application No. 61/691,690. This is the nonprovisional counterpart.

### CROSS REFERENCE TO RELATED APPLICATIONS

Most current methods for phishing detection are aimed at finding phishing websites instead of classifying emails as legitimate or phishing. The disadvantage is that a user may have to visit the site in which case malware could be installed on the user's machine without the user's knowledge. There are a few email and some website classification methods that use blacklists, or whitelists, of sites. For example, in Microsoft patent (U.S. Pat. No. 8,495,737), blacklists are employed to classify emails as spam. Such methods have the disadvantage that they cannot detect newly created phishing sites that are not yet in the blacklist. Whitelist based methods can mark a lot of sites as phishing since legitimate sites that are not on the whitelist cannot be classified properly.

McAfee patent (U.S. Pat. No. 7,937,480) aggregates reputation data from multiple local reputation engines, where the local reputation engines can use a “phishing characteristic.” However, no algorithm is given for deriving the said phishing characteristic. McAfee patent (U.S. Pat. No. 8,132,250) is similar to the previous McAfee patent mentioned.

A patent from Palo Alto Research Center (U.S. Pat. No. 7,860,885) is for classifying emails as spam or legitimate. However, their method differs from the invention described below in two respects: it does not use the domains of the links in the email for the search, and the way the search results are used is also different. A patent from NTT DoCoMo (U.S. Pat. No. 7,890,588) aims to detect unwanted emails. However, the authors process the limited information selected in a completely different way from this invention. Moreover, these methods have the following additional drawbacks: (i) they are not as comprehensive as the method described herein, since they do not use the text in the email in a comparable manner as this invention, and (ii) neither method uses the context of the emails as defined and used in the method described herein.

Furthermore, spam emails are typically advertising emails in which the sender is not overly concerned about detection, whereas phishing emails are designed to resemble legitimate emails as much as possible since the sender's goal is to steal sensitive information from email users.

### FIELD OF THE INVENTION

This disclosure relates in general to the field of phishing, more particularly to a comprehensive natural language based scheme to detect phishing emails.

### BACKGROUND OF THE INVENTION

Phishing is a social engineering threat aimed at gleaning sensitive information from unsuspecting victims.

Phishing attacks are usually carried out via communication channels such as email or instant messaging by “attackers” posing as legitimate and trustworthy entities. Email is still one of the most commonly used mediums to launch phishing attacks.

Different research groups have studied phishing from various perspectives: server-side and browser-side strategies, education/training, and evaluation of anti-phishing tools, detection schemes, and studies that analyze the reasons behind the success of phishing attacks.

There are two primary classifications of phishing detection schemes: schemes that detect phishing based on analyzing content of the target web pages (analyzing the web pages whose links are within the email) and schemes that operate directly on the content of the emails. The schemes for detecting phishing attacks (email and web pages) in the literature can be broadly classified into three categories: 1. Schemes based on information retrieval, 2. Machine learning based techniques and 3. String, pattern and visual matching based detection schemes. Before the advent of such schemes, the most popular (and still a widely-deployed solution) was the integration of blacklist-based anti-phishing techniques into browsers. It has been shown that blacklists are ineffective for protecting users from phishing attacks initially. Domain highlighting has also been employed in the past but is not shown to be very effective in preventing phishing. Domain highlighting is a feature built into the latest versions of several popular browsers. This feature enables the browser to show the true domain of the page a user is visiting.

A typical approach to detect phishing using web page content is analyzing the structure of the URLs and validating the authenticity of the content of these target web pages. One such scheme is a content-based approach to detecting phishing websites, based on information retrieval and text mining algorithms. There are several researchers that detect phishing web pages based on visual similarity and on using watermarking techniques to thwart phishing.

Some current schemes available identify phishing URLs by analyzing only the structure of the links and not the content of the target web pages. Some features are described that can be used to distinguish a phishing URL from that of a benign URL. These features are used to detect phishing URLs. One available algorithm uses the phishing data provided by the anti-phishing working group (APWG) to extract generic characteristics of hyperlinks embedded in phishing emails.

Most phishing detection schemes that operate at the email level use machine learning techniques on a feature set. A classifier is trained on a set of features extracted from the email. After the training, this classifier is used to detect phishing emails from the email stream. Some of the common features are: presence or absence of JavaScript, HTML/plain-text email, IP addressed URLs, number of links/domains/dots, etc.

One of the important maintenance aspects of a machine learning phishing detection scheme is that these filters need to be updated on a regular basis. One scheme currently available employs a heuristic algorithm that performs simple header, link and a cursory text analysis (scanning for the presence of certain text filters) of incoming emails. Some researchers have studied the evolution of phishing email messages and developed a classification of phishing messages into two groups: flash and non-flash attacks, and classify phishing features into transitory and pervasive. A study conducted on the anatomy of phishing emails used a database of fraudulent emails received by the associated organization in an effort to understand the structure of a phishing email in addition to unraveling the most common tricks used by phishers.

The approaches and technological schemes described in this section could be pursued, but are not necessarily approaches that have been previously conceived or pursued. Therefore, unless specifically indicated herein, the approaches and technological schemes described in this and subsequent sections are not admitted to be prior art by inclusion in this application.

### BRIEF SUMMARY OF THE INVENTION

The present disclosure relates to a comprehensive and effective natural language based scheme for detecting phishing emails.

One embodiment of the inventive scheme, PhishNet-NLP™ (a trademark of the University of Houston), is a comprehensive scheme that makes use of all the information present in an email, except attachments, to ascertain which class it belongs to: phishing or legitimate. The embodiment makes use of information present in the email header, text in the email body, and the links embedded in the email. Inventive techniques are employed to process the header and link information, and deeper natural language techniques are used to process the text information.

Natural language processing (NLP) by computers is well recognized to be a very challenging task because of the inherent ambiguity and rich structure of natural languages. The level of difficulty associated with NLP could be a reason why previous researchers have not used NLP techniques for email phishing detection. Despite this difficulty, two of the inventive schemes described herein match or outperform most existing phishing detection strategies in the literature and has been shown to obtain a phishing detection rate of about 97% or better with very low false positives of about 0.7-0.8%.

The inventive scheme is built on the observation that the fundamental difference between a phishing and a legitimate email lies in its objective. While a legitimate email typically conveys some information to the reader, a phishing email is designed to elicit a response. This response often involves making the reader click a link with the intention of obtaining sensitive personal information. None of the detection schemes in the literature available appear to make use of this distinction to detect phishing emails. The inventive scheme is designed specifically to distinguish between “actionable” and “informational” emails, focusing on objectives that are typical of phishing emails—language that intends to create a sense of urgency, threat, worry, concern or offers an incentive to the user to perform an action.

One embodiment of the inventive scheme uses feature selection by applying statistical tests on a set of email texts that are labeled as either phishing or non-phishing. The features are then used to create a classifier that distinguishes between informational and actionable emails. The results show that the feature selection significantly boosts the performance of the phishing classifier.

One embodiment of the inventive scheme uses contextual information (when available) to detect phishing. The problem of phishing detection is studied within the contextual confines of the user's mail box and it is shown that context plays an important role in detection to help minimize the detection time, computation involved in the detection, and finally to conserve bandwidth by limiting expensive online queries.

Contextual phishing detection outperforms many other non-contextual detection schemes in the current literature and appears to be the first contextual scheme known in the field. Additionally, the use of context information makes the inventive scheme robust against attacks that are aware of the inventive scheme's methods.

Detecting phishing at the email level rather than detecting fraudulent and masqueraded websites after the website has been visited by the user is one strategy employed in the inventive embodiments. One inventive embodiment operates between a user's mail transfer agent (MTA) and mail user agent (MUA) and processes each arriving email for phishing attacks. This prevents the user from clicking any harmful link in the email. This approach is in contrast to schemes that analyze the target websites for authenticity. The motivation to operate at the email level is due to the fact that clicking on the link and visiting a phishing website exposes the user to potential malware that could be installed by the website. Furthermore, the objective is to maximize the distance between the user and the phisher—clicking a malicious link puts the user closer to the threat. The added advantage of this approach is that internet service providers (ISPs) and email providers may now be able to prevent such emails from being delivered to the user thereby saving precious bandwidth as well.

Another inventive embodiment devises two independent, unsupervised classifiers, namely the link and header classifiers, and two combinations of these classifiers. This embodiment appears to be the first of its kind to make use of all facets of header and link information available in an email. This scheme is completely unsupervised, requiring no corpus of emails and no training. One such embodiment, Intersection, appears to match or outperform most existing phishing detection strategies in the literature and has a phishing detecting rate of about 93% or better with low false positives of about 0.5%. Another embodiment, Union, has a phishing detection rate over 99% with a false positive rate of about 6%.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following Figures and detailed description. It is intended that all such additional systems, methods, features and advantages that are included within this description, be within the scope of any claims appended below.

### BRIEF DESCRIPTIONS OF THE FIGURES

The novel features believed to be characteristic of the invention are set forth in the claims appended below. The invention itself, however, as well as a preferred mode of use, further objectives, and advantages thereof, will best be understood with reference to the following detailed description of an illustrative embodiment when read in conjunction with the accompanying drawings, wherein:

FIG. 1 shows a tiny WordNet® (a registered trademark of Trustees of Princeton University) hypernymy tree

FIG. 2 shows an algorithm for the PhishNet-NLP™ (a trademark of University of Houston) embodiment used to detect phishing emails using header, link and text analysis

FIG. 3 shows Algorithm 2 for the PhishSnag™ (a trademark of University of Houston) embodiment used to detect phishing emails using header and link analysis

FIG. 4 shows a prototype implementation of all the embodiments in a computer system

FIG. 5 shows the flowchart for PhishNet-NLP™ embodiment

FIG. 6 shows results obtained from running the PhishNet-NLP™ embodiment

FIG. 7 shows results obtained from running the PhishSnag™ embodiment

FIG. 8 shows the flowchart for training algorithm of PhishSem™ (a trademark of the University of Houston) embodiment

FIG. 9 shows the performance results for the text-only classifier PhishSem™.

Note that many of the functions may be reordered without adversely affecting the effectiveness of the embodiments and our choice of ordering in such cases is purely exemplary.

Note also that the text-only classifier PhishSem™ can be combined with header and link analysis yielding a comprehensive phishing email detection engine just as in PhishNet-NLP™.

### DETAILED DESCRIPTION

While the invention has been described with respect to a limited number of embodiments, the specific features of one embodiment should not necessarily be attributed to other embodiments of the invention; however, in some embodiments, features could be removed and/or combined with one or more features of the other embodiments to create additional embodiments. No single embodiment is representative of all aspects of the inventions. Moreover, variations and modifications therefrom exist. For example, the invention described herein may comprise other algorithms. Various steps may also be added to further enhance one or more properties. In addition, some embodiments of the methods described herein consist of or consist essentially of the enumerated steps. The claims appended below are intended to cover all such variations and modifications as falling within the scope of the invention.

### Text Analysis Scheme

One embodiment of the enclosed inventive scheme is based on a context based text analysis of emails. This particular disclosed embodiment appears to be the first scheme to utilize natural language based techniques, and context information when available, to detect phishing. One such embodiment, referred to as PhishNet-NLP™, operates by inferring the “intention” of the email—whether it is informational or actionable. Based on current experimentation, the phishing detection rate associated with the inventive scheme is at least 97% with very low false positives (about 0.7%-0.8%). PhishNet-NLP™ also utilizes all of the information available in an email, namely, the header, links and text of an email. The embodied scheme may also operate in the default mode and perform phishing detection in the absence of any history (this feature being under the control of the user). When prior history is available, the embodied scheme takes advantage and improves the detection capability. Finally, the embodied scheme is designed to detect phishing at the email level rather than detecting fraudulent, masqueraded websites thereby protecting the user in a comprehensive manner.

The embodiments may make use of Term Frequency-Inverse Document Frequency (TF-IDF). In information retrieval TF-IDF is a weight used to determine the importance of a word to a document in a collection of documents. The Importance of a word increases proportionally to the number of times a word appears in the document (term frequency) and is inversely proportional to the document frequency of the word in the collection. The IDF is a measure of the discriminating power of the term. It measures how common a term is across an entire collection of documents. Thus, a term has a high TF-IDF weight by having a high term frequency in a given document and a low document frequency in the whole collection of documents.

One embodiment of the inventive scheme, PhishNet-NLP™ is comprised of many steps. The first step may be referred to as parsing, which involves accepting an incoming email from the MTA and parsing it into its constituent components: header, links, and text. If the email is HTML encoded, as indicated by the header, the HTML email body is further decoded to plain text to perform further analysis. The header, links, and text, are analyzed through their respective classifiers and majority voting is performed on the scores obtained from the analysis classifiers to determine whether the email is legitimate or phishing.

Majority voting is used as opposed to considering certain weight factors for each of the individual classifiers in order to assign an equal importance to each of the classifiers. Under the assumption of independence, the majority voting approach has better coverage (accuracy) than that of each individual classifier whenever each classifier in the combination has better than a 50% coverage (accuracy). Majority voting also may help to avoid the following problems: (i) how to compute optimal weights, which requires a training corpus, and (ii) the optimal weight combination is likely to be different for different corpus and users.

The email text may be analyzed and given a score, referred to as Textscore herein. When the context information of an email is available, which is defined as the other saved emails of the user's mailbox, both sent and received, PhishNet-NLP™ may use the context to generate a score called Contextscore for the email as well. The user is given full control over PhishNet-NLP™'s context analysis option: whether or not to use context analysis, the context size to use for context analysis, and the date at which the context should start. In one embodiment, context size could be specified in two ways: number of emails or a date range. When the context option is used, the two scores, the Contextscore and the Textscore, are combined logically.

A semantics-based method may be employed to generate the Textscore of the email as well. The semantic approach may employ the following NLP techniques, including but not limited to: lexical analysis, part-of-speech tagging, named entity recognition, normalization of words to lower case, stemming and stopword removal.

The goal of lexical analysis is to split the email into sentences and each sentence into words.

The part-of-speech tagging phase tags each word with its part-of-speech, namely, noun, verb, etc.

Named entity recognition tags the named entities in the email, which are nouns that name person, location, or organization. Words are converted to lower case in a normalization phase. The goal of stemming is to reduce each word form to its root or stem. One such program for stemming is the Porter stemmer.

The textAnalysis Classifier of some embodiments may employ WordNet®. WordNet® combines features of both a dictionary and a thesaurus. The building block in WordNet® is a synset (a set of synonyms), which consists of all the words that express a given concept, and the basic semantic relation in WordNet® is synonymy.

The semantic relation that is the most important in organizing nouns into a hierarchy is the hyponymy relation between synsets. Hyponymy is the relation of subordination (or class inclusion or subsumption). The key point to be noted is that although the hypernymy relation is defined on synsets in WordNet®, it could be the case that a synset can have more than one hypernym. However, this situation is not frequent for nouns. On the other hand, for verbs the situation is quite different and the hyponymy structure is not even acyclic. The relation between verbs to other verbs may be used by the inventive embodiments.

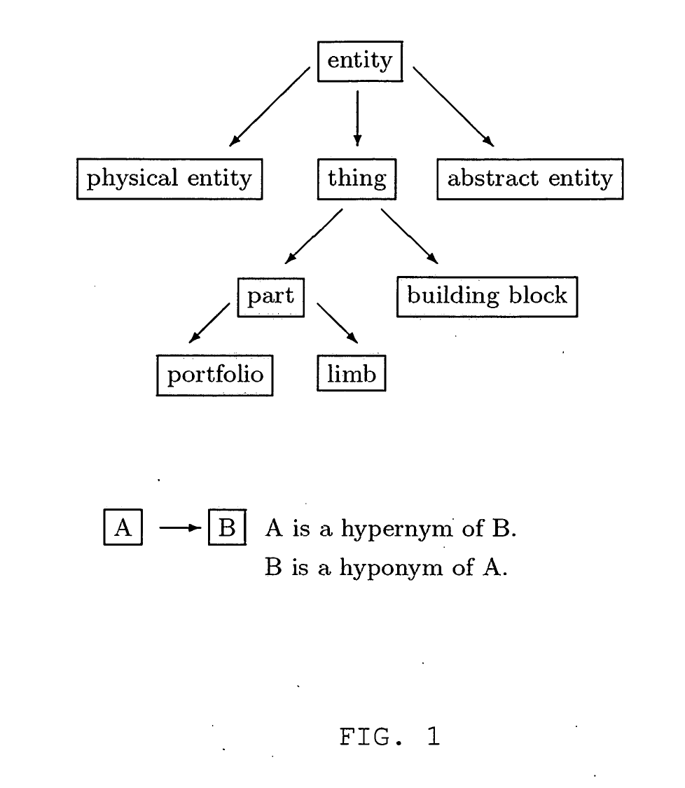

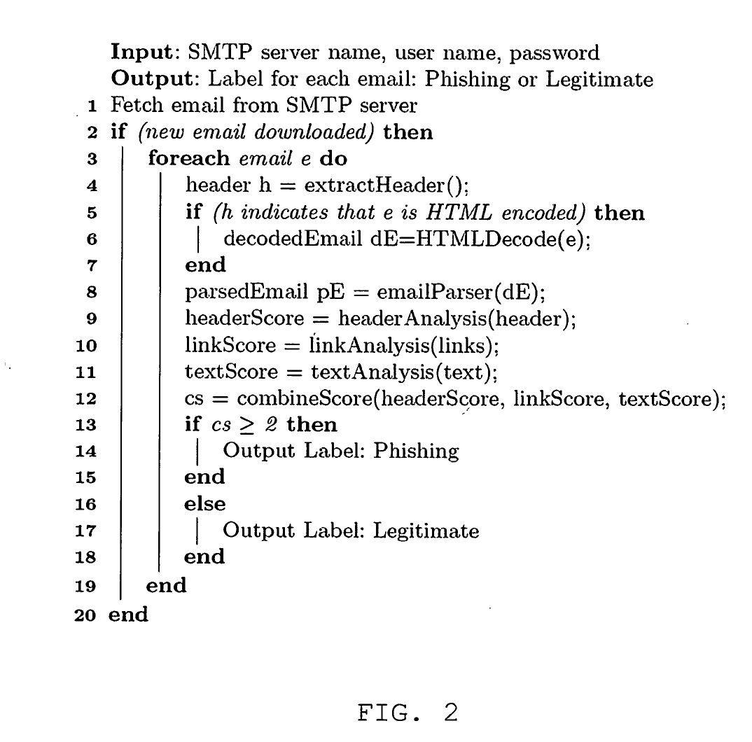

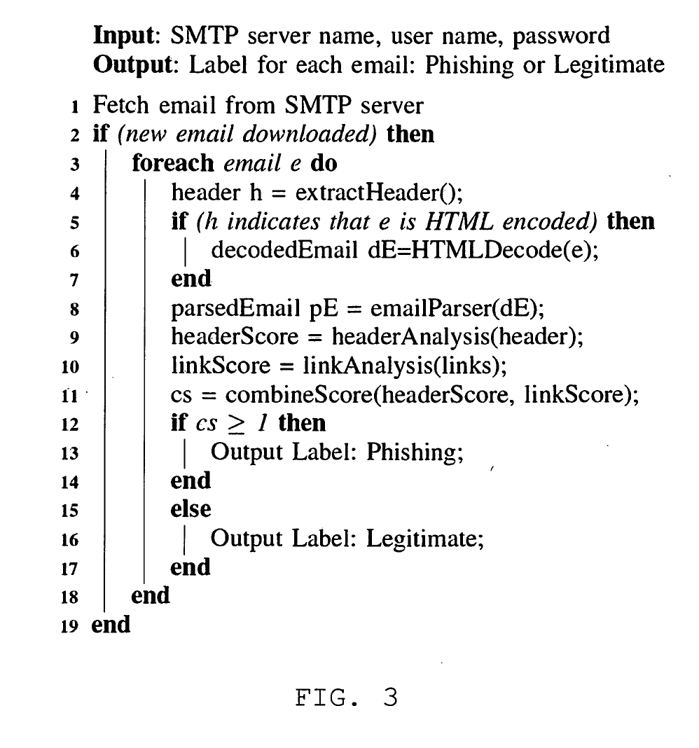

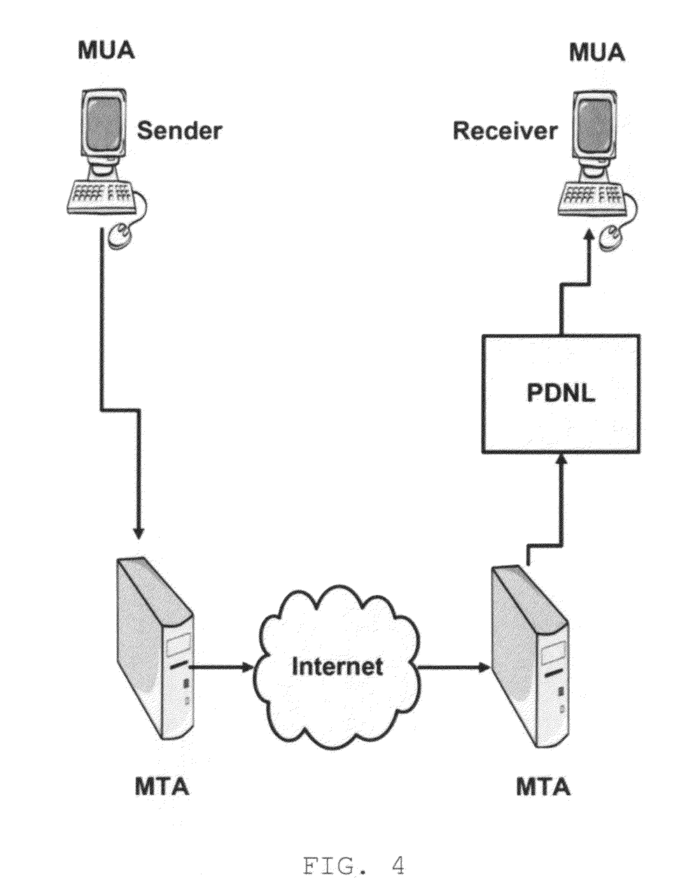

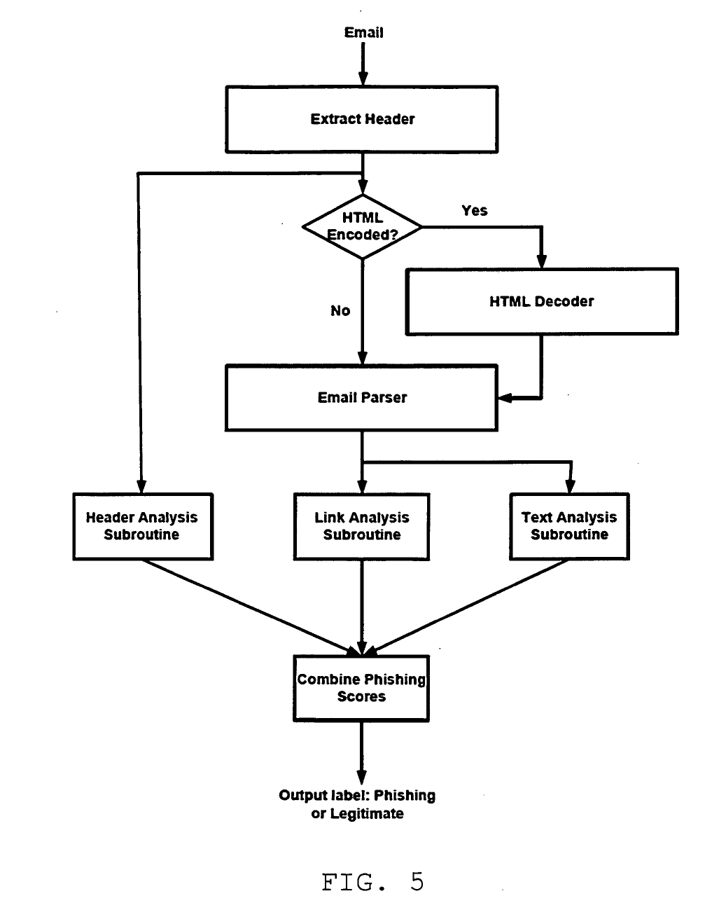

The hyponymy relation between verbs may be employed and is defined as follows: A is a hypernym of B if the meaning of A encompasses the meaning of B (B is called the hyponym). All nouns in WordNet® are stored in a graph (that is close to a tree) that represents the hypernymy hierarchy. The word entity is the root of the tree, because it is believed to encompass the meaning of all other nouns. Traversing down the tree manifests more specific nouns as shown in FIG. 1 of a small portion of the hypernymy tree. All verbs in WordNet® are arranged in a hypernymy graph as well, but for verbs this graph is “forest-like” but not a forest due to the presence of cycles.

The word sense disambiguation software may need to be invoked before calling the WordNet® program because a synset is designed to refer to a single concept and hence the need to disambiguate words in the document to find the correct synset for a noun. As an example, the word “plant” could mean a factory in one context and could mean a tree in another context. Hence the word plant would be found in two different synsets in this case.

The aim of stopword removal is to remove common words such as it, a, an, the, etc. Stopword removal may include removal of common suffixes such as Jr., Sr., II, etc., after names and prefixes such as titles like Dr., Prof., Mr., Ms., etc. For this purpose a stopword list may be used.

Semantic NLP techniques, namely word-sense disambiguation and WordNet®, may be used as opposed to purely syntactic or statistical ones based on feature counting. The sense or meaning of a word depends on its context. The goal of word-sense disambiguation is to find the appropriate sense of a word based on the context.

PhishNet-NLP™ utilizes deeper word analysis by extracting important words from the email text, tagging them with their senses based on the surrounding contexts of the words, and using these to query WordNet®. These distinguished words may be called keywords. The sense of the word may be used in locating the word in the WordNet® hypernymy tree and to generate a score for the word as described below. SenseLearner may be employed for word sense disambiguation and TextRank may be employed for keyword extraction. In one instance, SenseLearner was trained using the SemCor 2.1 database, which was compiled using WordNet® 2.1 but other methods may be employed.

The inventive scheme may be carried out by an analysis detailed and described herein, but other analysis techniques may be employed. For a user u, let Basic-Names(u) denote the lower-case versions of u's last name, first name, middle name(s), if any, and their common spelling variants. This set may be initialized by the user. Let Names(u) denote all permutations of words from Basic-Names(u) taken two at a time, three at a time, and so on until |Basic-Names(u)| at a time (where |S| denotes the size of set S). For an email text, e, let Named-entity(e) denote the set of named entities in e, ignoring only the greeting part of the email, which may be identified easily as a sentence fragment using parsing, or heuristics such as missing verb and presence of named-entity from Names(u). If |Named-entity(e)−Names(u)|=0, then email e receives an overall Textscore of 0, where a score of 1 represents phishing and 0 represents a legitimate email. Phishing emails are very likely to mention at least one institution in the body of the email. Next, assume that |Named-entity(e)−Names(u)|≧1. Since determining the extent to which an email is actionable is the desired outcome, certain verbs in the body of the email are scored. If the email contains no text it is marked as phishing. This means the email has either links or attachments only and the classification of the email is based on the reasonable assumption that legitimate email senders usually write a brief explanation of the links or attachments that they are sending out.

Let V={click, follow, visit, go, update, apply, submit, confirm, cancel, dispute, enroll}. To each word in the set V, the appropriate verb sense (denoted by #v at the end of the word in WordNet®) is attached. For any set X containing words along with a sense for each word, let Synset (X)={synset (x)|xεX}, where synset (x) is the WordNet® synset of x for the specified sense. For natural number i≧1, let Hypoⁱ (Synset (V)) denote the union of all the synsets reached by following up to i hyponymy links from the synsets in Synset (V). Let SV=Hypo⁴ (Synset (V)) be the set of special verbs. Note that the WordNet® verb hierarchy is not a tree structure and is not even acyclic, which means that following the hyponymy links must be done together with cycle detection. Let SA=Synset({here, there, herein, therein, hereto, thereto, hither, thither, hitherto, thitherto}) with each word in this set SA having the adverb sense, and let U={now, nowadays, present, today, instantly, straightaway, straight, directly, once, forthwith, urgently, desperately, immediately, within, inside, soon, shortly, presently, before, ahead, front} (words conveying a sense of urgency), and D={above, below, under, lower, upper, in, on, into, between, besides, succeeding, trailing, beginning, end, this, that, right, left, east, north, west, south} (the set of direction words). The above word choices were chosen based on a study of some phishing emails previously received by inventors, and a scan of about 20 (0.4%) emails in the phishing email database, but other word choices may be used to achieve similar results. The examples presented give some of the possible scoring functions to obtain Textscore of an email when there is at least one named entity besides user name(s).

For the Contextscore, the email may be treated as a vector of TF-IDF values in the semantics space as opposed to traditional syntactic techniques after stopword elimination and stemming. Note that the TF-IDF scheme converts a vector of words to a vector of real values using the product of term frequency and inverse document (here, the document is the email) frequency. WordNet® may again be employed for this purpose after part-of-speech (POS) tagging and word sense disambiguation. Words belonging to the same synset are represented by a common word in the vector. For instance, different forms of the same verb “is”, “was”, etc. are represented by the common verb “to be.” Also, different verbs with the same sense and meaning such as “is,” “exists”, etc. are also represented by the verb “to be.”

Then the similarity computation is performed between the email vector ev and the corresponding vector for each email in the context, say ec. For the similarity computation the cosine measure is adopted, Similarity(ev, ec)=cosine θ, where θ is the angle between the two vectors. The smaller the θ, the greater the similarity between two emails. Note, that other similarity methods can be adopted as well and our choice is purely exemplary. Finally, Contextscore (ev)=max_{ecεC}Similarity(ev, ec). The size of the intersection is also computed by I|Named-entity(ev)∩Named-entity(ec)| for each email ec, with similarity of over high-threshold. If this intersection is null, then the Contextscore is lowered down to 0. If Contextscore is below low-threshold it is rounded down to 0. If it is above high-threshold and the size of the intersection is at least one, then it is rounded up to 1. Low-threshold and high-threshold are initially set to about 0.5 (an angle of about 60 degrees or higher) and about √3/2 (an angle of about 30 degrees or lower) respectively and can be fine-tuned further, if necessary, based on experiments. No rounding is performed if Contextscore is between low-threshold and high-threshold.

For efficiency purposes PhishNet-NLP™ saves the vocabulary and named-entity information for the context examined, and the corresponding vectors for the emails examined in a database for subsequent reuse. Multiple indices can be constructed on this information for efficient retrieval based on the context options provided in PhishNet-NLP™.

In an exemplary embodiment, Textscore(e) and Contextscore(e) may be combined to yield Final-text-score(e). If no context information is available, Final-text-score(e)=1 if Textscore(e)≧1, otherwise Final-text-score(e)=0. When context information is available, the following procedure may be used: if Contextscore(e)=1 and any one of the emails that yield the maximum similarity score is marked as dangerous (phishing) by the user, the Final-text-score(e)=1. If Contextscore(e)=1 and all of the emails that yield the maximum similarity score are marked safe (legitimate) by the user, then Final-text-score(e)=0. If Contextscore(e)=0, then the email is not very similar to any email in the context. In this case, Final-text-score(e)=0 if Textscore(e)<1, otherwise Final-text-score(e)=1. If low-threshold < Contextscore(e)< high-threshold, then the email has moderate similarity to some email in the context. In this case, if Textscore(e)<1, then Final-text-score(e)=0, else Final-text-score(e)=1.

If user input is acceptable (or if the user chooses interactive mode), then the user could be queried to determine whether the email has arisen from some past action of the user. This could be useful in two “gray” areas where Contextscore is between low and high threshold and Textscore is less than 0.5, and Contextscore is zero and Textscore is between 0.5 and 1. If 0. 5≦Textscore(e)<1, the user could be prompted to determine if the email has arisen from some past action of the user. If yes, Final-text-score(e)=0, otherwise Final-text-score(e)=1. In order to simplify the logical combination, the context score may be rounded down to 0 if it is between about 0 to 0.866 (angle greater than about 30 degrees) and rounded up to 1 otherwise. These thresholds were not fine-tuned using the data but can be if desired. To maintain user's privacy, context analysis can be a separate application that works under user control without downloading user emails into its space.

The header analysis classifier employed in the inventive scheme differs from the routine presented by other available schemes in several aspects including, but not limited to: (i) dealing with email forwarding issues, (ii) making use of DomainKeys Identified Mail (DKIM) and Sender Policy Framework (SPF) information whenever they are available, and (iii) accounting for the differences in the headers based on whether the email is sent from a mobile device or relayed by multiple servers in the user's domain. The headerAnalysis( ) classifier performs analysis on the data from the extracted headers to determine whether the email is phishing. A possible first step may request that the user input his/her other email addresses that forward emails to this current email address and this information is stored. It can be assumed that these forwarding email accounts and the Local Host also have PhishNet-NLP™ or other embodiments described herein installed.

A possible first phase of this header classifier embodiment involves extracting the data. The FROM and DELIVERED-TO fields are extracted from the header. Then, the RECEIVED FROM field(s) may be extracted and looked at in order, starting with the first such field and then the next such field, if present, and so on.

The received from field(s) may be extracted as follows:
If the Received From section of the email contains a DKIM signature then store the Signing Domain Identifier [SDID].
Otherwise, if there is a Received-SPF field below a Received From field, then first store the Received From field. Additionally, if the SPF query returns “pass,” and if the domain in the From Field accepts an IP address as a permitted sender in the Received-SPF field, perform an NSLOOKUP on this IP address and store the domain name corresponding to this IP address in the variable SPFQuery.
Otherwise, store the RECEIVED FROM field.

A possible second phase involves verifying the data. The data may be verified as follows:
If the first Received From field has the same domain name as the FROM FIELD or LOCALHOST or ANY FORWARDING EMAIL ACCOUNT, or if the NSLOOKUP on the IP address of the permitted sender in the Received-SPF field yields the same domain name stored in the variable SPFQuery, then this email is legitimate.
Otherwise, if the first Received From field has the same domain name as the user's current email account's domain name, then look at the next received from field.
Otherwise, mark the email as phishing.

The link analysis classifier of the inventive scheme is used to determine whether the URLs present in the email point to the legitimate websites that the text in the body of the email claims. All domains may be extracted from the links in the email into an array (let this array be called DOMAINS). The linkAnalysis( ) classifier assigns an email a score of 1 for phishing and 0 for legitimate as follows:
If the length of DOMAINS is 0 (no links), the email is legitimate.
If the email has more than 10 distinct words, calculate the top four terms in the email using the TF-IDF scores. The IDF value of a word can be obtained in many ways, for example, doing a Google® search for the word, and obtaining the number of web pages in which it appears, or by using a standard NLP corpus. If the Google® search approach is adopted, the search information, together with the total number of web pages in Google®'s database, can be used to calculate the IDF value for each word. However, note that Google® returns only a somewhat loose upper bound on the number of web pages containing the word for efficiency purposes, which is progressively refined as the user examines the search results list. For this reason and the fact that Google® discourages frequent automated searching, the email database itself was used to estimate the IDF value in this embodiment. Google® search each domain together with the top four terms. Other search engines may also be used.
Otherwise, if the total number of distinct words in the email is less than 10, then Google® search each domain. If all domains appear in the top 30 results returned by the Google® search, then mark the email as legitimate, otherwise phishing. The reason for insisting on 10 words as a threshold is to offset the very small likelihood of obtaining at least four content words in a text fragment that is shorter.

Recall that a score of 1 represents phishing and 0 stands for legitimate. If the combined score of the three classifiers (header, link and text) is ≧2, PhishNet-NLP™ labels the email phishing, otherwise it labels it legitimate.

On a database of 2000 phishing emails (using the same phishing corpus as a current phishing scheme available), the percentage of emails that are marked by PhishNet-NLP™ as phishing is over 98% compared to other phishing schemes that had results in the low 80%. On 1000 legitimate emails, PhishNet-NLP™ marked 99.3% of the emails as legitimate compared to 99% for other phishing schemes. However, note that the legitimate email databases are different in this case since the authors of other schemes do not mention how they collected their legitimate emails.

Coverage was therefore increased by about 18% for the phishing emails while obtaining higher accuracy. Furthermore, the header analysis classifier incorporated into the inventive scheme is more advanced than other available schemes in the sense that it also deals with email forwarding issues and accounts for the differences in the headers based on whether the email is sent from a mobile device or relayed by multiple servers in the user's domain.

The header analysis scheme goes beyond that of other available schemes and examines DKIM signatures and SPF fields when available. Although the phishing corpus emails were collected five to eight years ago, it is still considered a good database since phishing sites are so short-lived that the link analysis results should not change significantly even when run on more recent phishing emails. Other experiments performed were focused on the detection of masqueraded web pages rather than on phishing emails and experimented with only 100 websites. Still, a much higher false positive rate was shown for legitimate web pages and lower coverage of masqueraded sites. Moreover, other available algorithms exhibit a tradeoff between coverage and accuracy. In contrast, the first run coverage of the present inventive scheme (without context information) is never lower than about 97.7% for the largest phishing database (which contained about 4550 phishing emails) and simultaneously achieves high accuracy with high coverage.

Other schemes researched apply machine learning techniques on a set of about 860 phishing emails, and about 6950 non-phishing emails, and are able to correctly identify about 92% of the phishing emails with about 0.1% false positive rate. Using structural properties of emails, some available schemes were able to detect 95% of phishing emails but do not explicitly state their false positive percentages. It is important to note that the above mentioned machine learning approaches require a training corpus of emails whereas the inventive approach does not. The present results show that all three classifiers satisfy the minimum threshold needed for helping to improve the combined classifier since they are all above about 50% in coverage and accuracy. However, there is some dependence between the text analysis and link analysis classifiers since one analyzes links and the other uses the presence of links in its scoring. However, because links are central to phishing via emails, this trade off is acceptable.

The relatively lower percentage of phishing emails detected by textAnalysis( ) in two large mail boxes is explained by the imprecision of NLP tools and the following three types of emails: foreign language, emails with unusable text, and emails with tables and pictures and insufficient text. Also, in each individual mailbox, the 2nd run produced an increased phishing detection by the textAnalysis( ) classifier and a small increase in the overall phishing detection. This is a direct consequence of the effect of the Context Score, which was not available in the first runs, but available in the 2nd runs after the first runs assigned scores to each email in the database. A higher detection rate could possibly be achieved on the first run of textAnalysis( ) by using the previous context of the first N emails when processing email N+1. However, it may be preferred to keep a fixed context for analysis of each email rather than a growing context, since in this case the present results are insensitive to the order in which emails are processed.

In one embodiment PhishNet-NLP™ was implemented using Perl® (a registered trademark of The Perl Foundation) v5.12.4, WordNet® version 2.1 and SenseLearner 2.0, but other implementations can be utilized. In one embodiment the Stanford® (a registered trademark of Stanford University) POS tagger 2006-05-21 and Stanford® Named Entity Recognizer 1.0 were used. One implementation platform that may be used is a Corer™ (a trademark of Intel Corporation) 2 Duo 2.66 GHz processor, 4 GB RAM machine running 32 bit Windows® (a registered trademark of Microsoft Corporation) 7. Cygwin™ (a trademark of Red Hat, Inc.) may be used for the POS tagger, NER, SenseLearner and WordNet®.

Some of the challenges that may be faced during implementation are: 1) The Google® Search API would not perform frequent automated searches but random delay of 10 to 20 seconds may be used after every search to circumvent this issue, and 2) Parsing an email into the constituent header and body and then extracting the text and links may be challenging since most emails are HTML encoded and the headers do not always end with the same line format. Given that a random sleep time was necessary between subsequent Google® searches, it may be desired to make use of different search engines for consecutive searches to eliminate this problem and possibly obtain better results.

Extracting data from emails relies on the use of regular expressions. From analyzing thousands of emails, it was observed that the message headers were formatted differently among them. A large number of email formats were studied to design the decoder (which decodes html if present, extracts info from the header and body and removes any attachments). If an attachment is present in an email, then the last portion of the message header contains one of the following: Content-Disposition: attachment or Content-Disposition: inline. This is followed by the encoded attachment file. This information was used to ignore all attachments.

Link and text analysis are very important and provide robustness to the inventive scheme. While the headerAnalysis( ) classifier alone shows very high coverage and high accuracy, the importance of link and text analysis stems from the fact that a sophisticated phisher can manipulate the originating “Received From”, “From,” and the “Delivered To” information to an extent.

Results from the LinkAnalysis show that it is very difficult to create a fraudulent link to bypass LinkAnalysis.

Unless the phishers have hacked into the mail server or the user's account, they would not have access to the context of the user's mailbox. Hence, it is likely that Context Analysis will also play a part in detecting such an email.

When someone hacks into an account in some domain and uses a friend list to attack any user in the same domain, headerAnalysis( ) may fail to detect this. But even in such a case, PhishNet-NLP™ can use the linkAnalysis( ) and textAnalysis( ) to mark the email as phishing since the intent of the email is to steal sensitive information by asking the user to click on a link for a malicious website. This even works for the scenario when user A's account is hacked and user A receives a phishing email. For example, if A's sensitive information is stored in an encrypted form.

Observe that with this implementation, textAnalysis( ) classifier will score the following email as phishing: “I found this video to be funny! Click on this link <legitimate link here>.” This email will be scored as phishing even when coming from a genuine sender and a legitimate link. This is not a limitation of the inventive approach but actually a design feature of PhishNet-NLP™. The reason is that both header and link analysis will have a high likelihood of returning a score of 0 (indicating legitimate) on such emails and therefore, the majority vote will be legitimate. While it may seem counterintuitive, is may be argued that such emails must be scored as phishing by the textAnalysis( ) classifier. For example, the consequence of a similar email, with a malicious link, being marked legitimate by textAnalysis( ) may be evaluated. Consider a sophisticated phisher who designs such an email with a malicious link. Let it be further assumed that the phisher is somehow able to successfully fool the headerAnalysis( ) classifier. Clearly, the majority vote would now indicate that this email is legitimate (the votes contributed by textAnalysis( ) and headerAnalysis( )since linkAnalysis( ) would be the only classifier to indicate phishing) allowing the phisher to escape detection.

As of the present inventive scheme, emails in foreign languages or emails with insufficient text (only links or attachments) present a challenge to the textAnalysis( ) classifier which leads to a low phishing detection rate by the textAnalysis( ) classifier. By using context analysis to correctly identify the email as phishing this challenge could be offset.

For efficiency, PhishNet-NLP™ is designed to first execute headerAnalysis( ) and linkAnalysis( ) on the email that is being analyzed. If the sum of the scores of these two classifiers is equal to 1, only then will PhishNet-NLP™ execute textAnalysis( )(because if the combined score is either 0 or 2 from the first two classifiers, then the score from textAnalysis( ) cannot change the final output label of PhishNet-NLP™). This feature was disabled during testing to obtain the results from each classifier.

As DKIM becomes widely deployed, sending domains will develop reputations as sources of spam or useful messages. It is thought that senders are not able to create covert sub-domains under their main domain (unless an authorized insider attacker is involved which may be unlikely) and cannot manipulate the “Received From” fields of legal intermediate MTAs. It is noted that it is not very easy to identify whether a “Received From” field is from a genuine intermediate MTA or just added by the phisher to confuse the header analysis. The highest probability for a “Received From” field of truly originating from a genuine intermediate MTA is the one closest to the recipient's domain, justifying the use of the closest MTA in the inventive scheme.

### Header and Link Analysis

Another embodiment of the inventive scheme, referred to as PhishSnag™, is a combination scheme and makes use of only the header and link information present in an email (except attachments) to ascertain which class it belongs to: phishing or legitimate.

The first step in the protocol of the embodiment may be parsing: where PhishSnag™ accepts an incoming email from the MTA and proceeds to parse it into its constituent components: header and links. If the email is HTML encoded, as indicated by the header, the HTML email body may then be decoded to plain text to perform further analysis. Having obtained the header and links, each component may be analyzed through their respective classifiers (headerAnalysis and linkAnalysis) as discussed below. PhishSnag™ Union (PhishSnag™ Intersection) then labels the email as phishing if either (or both) of the classifiers, headerAnalysis( ) and linkAnalysis( ) report phishing.

The header analysis classifier employed in the inventive scheme differs from the routine presented by other available schemes in several aspects including, but not limited to: (i) dealing with email forwarding issues, (ii) making use of DKIM and SPF information whenever they are available, and (iii) accounting for the differences in the headers based on whether the email is sent from a mobile device or relayed by multiple servers in the user's domain. The headerAnalysis( ) classifier performs analysis on the data from the extracted headers to determine whether the email is phishing. A possible first step may request that the user input his/her other email addresses that forward emails to this current email address and this information is stored. It may be assumed that these forwarding email accounts and the Local Host also have PhishSnag™ (or other embodiments described herein such as PhishNet-NLP™) installed.

The headerAnalysis( ) classifier may make use of DKIM and SPF information when available. DKIM is the core mechanism for signing and verifying e-mail messages. In DKIM, every organization (or person) has an “identity” which is captured using an identifier called the Signing Domain Identifier (SDID) and is contained in the DKIM-Signature header fields, thereby allowing an organization (or person) to take responsibility for a message in a way that can be verified by a recipient.

Sender Policy Framework (SPF) is an email validation system designed to thwart spam and phishing by detecting IP address spoofing. IP address spoofing is possible under the current implementation of the simple mail transfer protocol (smtp) that permits any computer to send emails claiming to be from any source address. To this end, SPF allows a domain administrator to specify which hosts on the domain are allowed to send email by creating specific SPF records in the Domain Name System. Receivers of a message can now check the SPF record and decide whether to accept or reject the message body, thereby reducing the bulk of spam and phishing messages delivered. The classifier described herein assigns an email a score of 1 for phishing and 0 for legitimate.

A possible first phase of this header classifier embodiment involves extracting the data. The FROM field may be extracted from the header. Then, the RECEIVED FROM field(s) may be extracted and looked at in order, starting with the first such field and then the next such field, if present, and so on. The received from field(s) may be extracted as follows:
If the Received From section of the email contains a DKIM signature then store the Signing Domain Identifier [SDID].
Otherwise, if there is a Received-SPF field below a Received From field, then first store the Received From field. Additionally, if the SPF query returns “pass,” and if the domain in the From Field accepts an IP address as a permitted sender in the Received-SPF field, perform an NSLOOKUP on this IP address, and store the domain name corresponding to this IP address in the variable SPFQuery.
Otherwise, store the RECEIVED FROM field.

A possible second phase involves verifying the data. The data may be verified as follows:
i. If the first Received From field has the same domain name as the FROM FIELD or LOCALHOST or ANY FORWARDING EMAIL ACCOUNT, or if the NSLOOKUP on the IP address of the permitted sender in the Received-SPF field yields the same domain name stored in the variable SPFQuery, then this email is legitimate.
ii. Otherwise, the email may be marked as phishing.

The link analysis classifier of the inventive scheme is used to determine whether the URLs present in the email point to the legitimate websites that the text in the body of the email claims. All domains may be extracted from the links in the email into an array (let this array be called DOMAINS). linkAnalysis( ) is programmed to make use of a database of phishing URLs to detect fraudulent links. The described implementation may utilize the PhishTank® (a registered trademark of OpenDNS, Inc.) database available online but other databases such as, APWG, Google Safe Browsing®, etc. may be used as well. linkAnalysis( ) may also use the Google® search engine and TF-IDF scores of the words in the email text to detect phishing links. Furthermore, it may store the phishing links detected by Google® search into an array, building a context of fraudulent links, which can be used to reduce further Google® queries and computations. Similarly, for efficiency purposes, linkAnalysis( ) may maintain a database of legitimate links, which are links verified by Google® search as legitimate at least three times. Domain redirections may also be accounted for and subjected to the described analysis. The linkAnalysis( ) classifier may assign an email a score of 1 for phishing and 0 for legitimate as follows:
If the length of DOMAINS is 0 (i.e. no links in email), then the email is legitimate.
Otherwise, if any of the domains in the embedded email links match an entry in the PhishTank® database, then the email is labeled phishing.
Otherwise, if any of these domains match an entry in the phishing context database, then the email is labeled phishing.
Otherwise, if the email has more than 10 distinct words, calculate the top four keywords in the email using the TF-IDF scores. The IDF value of a word can be obtained by either doing a Google® search for the word and obtaining the number of web pages in which it appears, or by using a standard natural language corpus. Google® search each domain together with the top 4 keywords.
Otherwise, if the total number of distinct words in the email is less than 10, then Google® search each domain. The reason for insisting on 10 words as a threshold is the very small likelihood of obtaining at least four content words in a text fragment that is shorter.
If all domains appear in the top 30 results returned by the Google® search, then mark the email as legitimate (score 0). Otherwise the email is marked phishing (score 1).

Our phishing email list was obtained from an online phishing corpus. This corpus has been used by prior research and, according to authors, it is the first such phishing corpus publicly available. In addition to the online corpus above, personal email accounts were also used consisting of 1,000 legitimate emails. Four classifiers are presented—headerAnalysis( ) linkAnalysis( ) Union( ) and Intersection( ) as described below:
i. Union( ) Classifier: If either headerAnalysis( ) OR linkAnalysis( ) reports PHISHING, then the email is labeled PHISHING.
ii. Intersection( ) Classifier: If both headerAnalysis( ) AND linkAnalysis( ) report PHISHING, then the email is labeled then email is PHISHING.

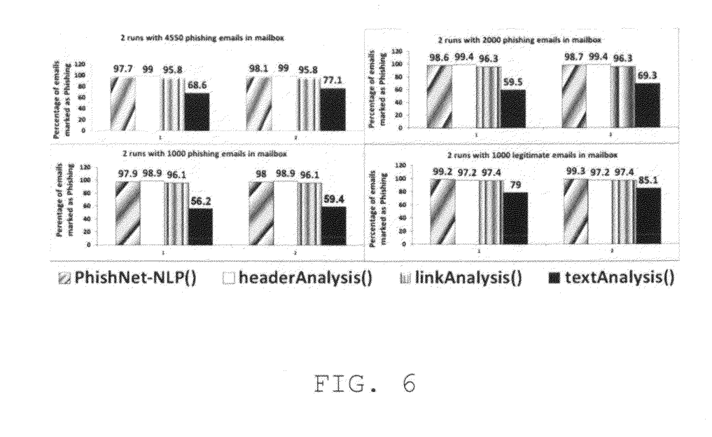

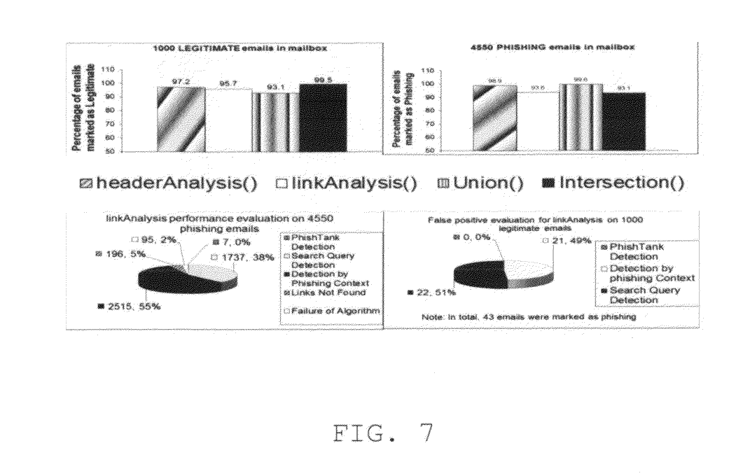

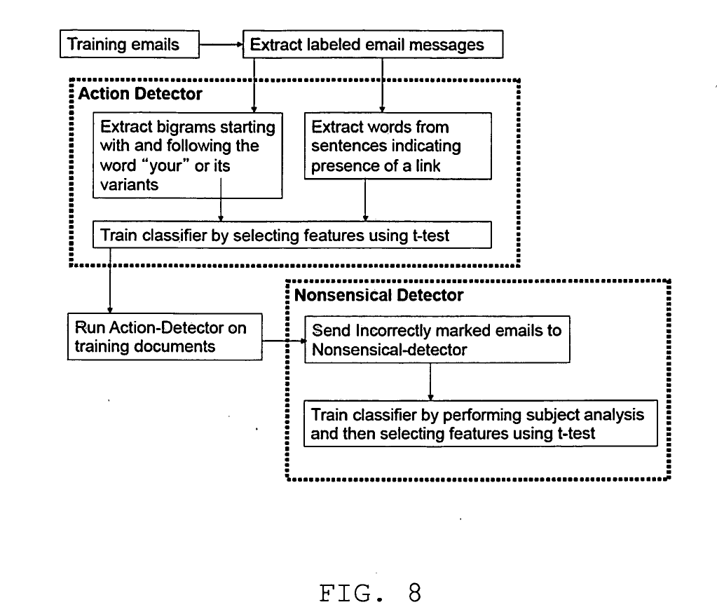

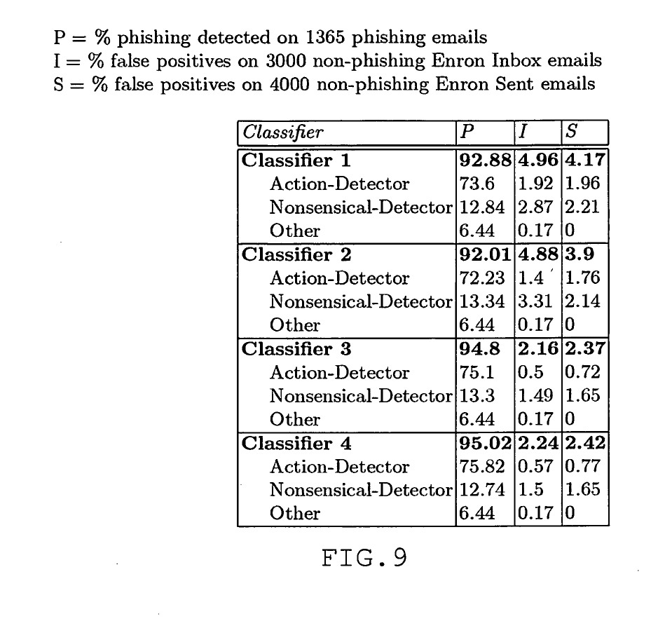

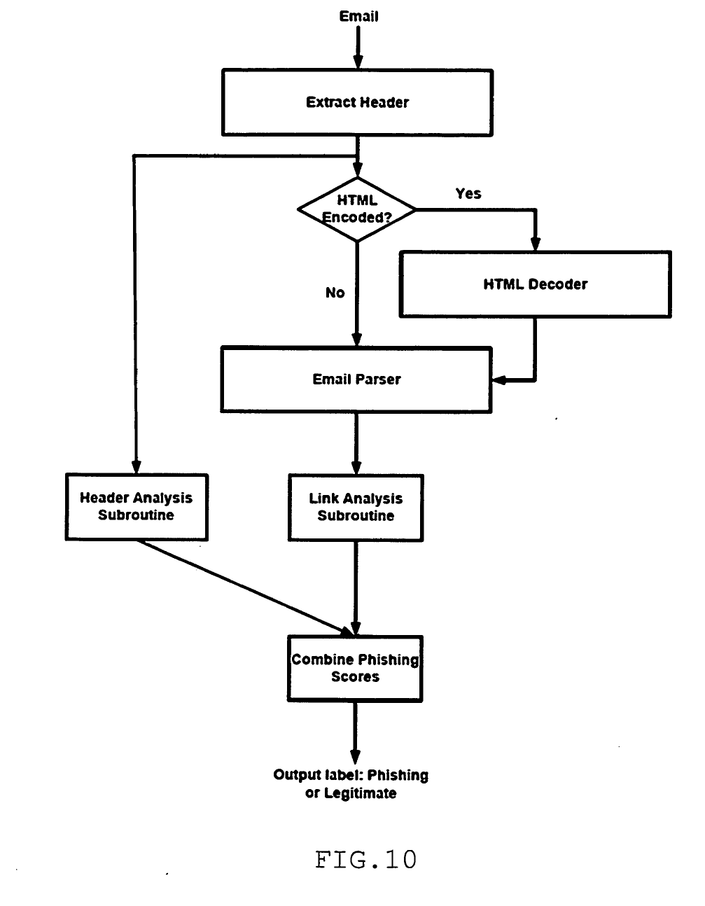

In reference to FIG. 6, the numbers in the pie charts are in the format “count, percentage”, where count stands for the actual number of the emails under that category in the pie chart and percentages are made over the 4550 emails in the first (left) pie chart and 43 false positives in the second (right) pie chart.

It was observed that about 41.3% of the legitimate emails did not have any links as opposed to about 4.3% for the phishing emails. This emphasizes that legitimate emails are commonly informational, generally meant to convey a message to the receiver. In contrast, phishing emails have the tendency to lure users into revealing personal information by invoking an action from the user's side. It was also noted that the size of the legitimate links context for the legitimate email database was 10 and the number of emails marked legitimate by this context was 304. It suggests that a legitimate mailbox tends to receive similar links. In other words, a mailbox owner has a certain range of interests that determines which links he or she is more likely to receive. For example, a person who is a member of an online retailer will be receiving many notifications and advertisements from the retailer with links having the same domain. Furthermore, the legitimate links context also reduces computations by taking advantage of this fact that a user tends to receive similar links frequently.

In one embodiment, PhishSnag™ was implemented using Perl® v5.12.4 on a Corer™ 2 Duo 2.66 GHz processor, 4 GB RAM machine running 32 bit Windows® 7, but other implementations may be utilized.

Some of the challenges that may be faced during implementation are:
The Google® Search API would not allow frequent automated searches. As a result, Bing™ (a trademark of Microsoft Corporation) was implemented, which does not have this problem, as a backup search engine. If Google® Search fails, then Bing™ search may be used. Google® may be prioritized over Bing™ because Google®'s search engine is accepted as the norm and it may be easier to compare results to prior research that used Google®.
For IDF calculations, if the Google® search approach is adopted, then the search information, together with the total number of web pages in Google®'s database, can be used to measure the IDF value for each word. However, Google® may return only a somewhat loose upper bound on the number of web pages containing the word for efficiency purposes, which is progressively refined as the user examines the search results list. For this reason and the fact that Google® discourages frequent automated searching, the email database itself was used to estimate the IDF value in evaluations.
Parsing an email into the constituent header and body and then extracting the text and links from it was challenging since most emails are HTML encoded and the headers do not always end with the same line format.

PhishSnag™ has been tested on Windows operating systems but may be adapted to other platforms. The method of extracting data from emails relies on the use of regular expressions. From analyzing thousands of emails, it was observed that the message headers were formatted differently among them. A large number of email formats were studied in order to design the decoder, which decodes html if present, extracts info from the header and body and removes any attachments. If an attachment is present in an email, then the last portion of the message header contains one of the following:

Content-Disposition: attachment

Content-Disposition: inline

This is followed by the encoded attachment file. This information is used to ignore all attachments.

While the headerAnalysis( ) classifier alone shows very high coverage and high accuracy, the importance of link analysis stems from the fact that a sophisticated phisher can manipulate the originating “Received From”, “From,” and the “Delivered To” information completely. To this end, link analysis is very important and provides robustness to the embodied combination schemes. Results from linkAnalysis( ) have also shown that it is very difficult to create a fraudulent link to bypass this classifier. Unless the phishers have hacked into the mail server or the user's account, they would not have access to the context of the user's mailbox. Hence, it is likely that the link context information will also play a part in detecting such an email while reducing computational overhead.

When someone hacks into an account in the same domain and uses a friend list to attack any user in the same domain, the headerAnalysis( ) may fail to detect this. But even in such a case, PhishSnag™ can use the linkAnalysis( ) classifier to mark the email as phishing since the intent of the email is still to steal sensitive information by asking the user to click on a link for a malicious website. This even works for the scenario when user A's account is hacked and user A receives a phishing email. For example, if A's sensitive information is stored in an encrypted form. This scenario motivates the union of the two schemes as opposed to the intersection.

PhishSnag™'s schemes are highly efficient since they do not require any training, ignore the text in the email, and makes use of on-the-fly databases of links databases, which may reduce searching.

As DKIM becomes widely deployed, sending domains will develop reputations as sources of spam or useful messages. DKIM provides an authentication mechanism for the email domain that sent the email. It is thought that senders are not able to create covert sub-domains under their main domain (unless an authorized insider attacker is involved which may be unlikely) and cannot manipulate the “Received From” fields of legal intermediate MTAs. It is noted that it is not very easy to identify whether a “Received From” field is from a genuine intermediate MTA or just added by the phisher to confuse the header analysis. The highest probability for a “Received From” field of truly originating from a genuine intermediate MTA is the one closest to the recipient's domain, justifying our use of the closest MTA in our scheme.

Redirection issues are handled with domains in the linkAnalysis( ) classifier. There are cases when a domain is not present in the top 30 Google® search results because it redirects to another website. This problem may be avoided by checking whether the redirected link belongs to the same search result set. If the redirected link is found in that set, then linkAnalysis( ) marks the redirecting domain as legitimate, otherwise it is marked as phishing.

Through inspection of headerAnalysis( ) it was observed that among the legitimate emails, about 21.3% had DKIM signatures and about 14.5% had SPF queries that passed. In contrast, for the phishing emails, there were no SPF queries that passed and no DKIM signatures.

On a database of 4550 phishing emails (using the same phishing corpus as other directly related schemes available), the percentage of emails that are marked by one embodiment, PhishSnag™, as phishing by Union (Intersection) is over about 99% (93%) compared to the other available schemes, having a result as low as 80%. On 1000 legitimate emails, Union (Intersection) marked over about 94% (99.5%) of the emails as legitimate compared to about 99% for other schemes. However, the legitimate email databases are different in this case since the authors of the other schemes do not mention how they collected their legitimate emails. In this sense, coverage was able to be increased significantly by about 13% with the Intersection algorithm for the phishing emails while increasing accuracy by about 0.5% simultaneously. Furthermore, the header and link analysis classifiers are far more advanced than other schemes in the sense that it also deals with email forwarding issues and accounts for the differences in the headers based on whether the email is sent from a mobile device or relayed by multiple servers in the user's domain. The inventive header analysis goes beyond that of other schemes and examines DKIM (DomainKeys Identified Mail) signatures and SPF (Sender Policy Framework) fields when available.

There are other schemes available that focus on the detection of masqueraded web pages rather than on phishing emails. These schemes experimented with only 100 websites. Still, they have a much higher false positive rate for legitimate web pages and lower coverage of masqueraded sites. Some other experimenters apply machine learning techniques on a set of about 860 phishing emails, and about 6950 non-phishing emails, and are able to correctly identify about 92% of the phishing emails with about a 0.1% false positive rate. Some schemes propose a learning algorithm that accepts a set of ten known features (IP based URLs, age of domain names, number of links, etc.) and decides whether an email is legitimate or phish. Some algorithms are first trained over a training data set followed by the evaluation phase using a separate test data set. Using derived structural properties of emails in conjunction with a SVM (Support Vector Machine) learning algorithm, some were able to detect about 95% of phishing emails but did not explicitly state any false positive percentages. Finally, it is important to note that the above-mentioned machine learning approaches require a training corpus of emails whereas the inventive approach eliminates this training overhead. In other words, supervised learning as proposed by available schemes is based on a training data set, whereas the inventive approach is unsupervised learning and does not require any training data. Moreover, machine learning techniques used by these researchers are prone to the well-known model over-fitting problem.

The invention will be further clarified by a consideration of the following examples, which are intended to be purely exemplary.

### EXAMPLES

### Example 1

Consider a phishing email in which the bad link, deeming the email phishing, appears in the top right-hand corner of the email and the email (among other things) directs the reader to “click the link above.” The score of verb vεSV being score (v)={1+x(l+a)}/2^{L}. The parameter x=1, if the sentence containing v also contains either a word from SA∪D and either a link or the word “url,” “link,” or “links” appears in the same sentence, otherwise, x=0. The parameter l=2, if the email has two or more links, l=1 if the email has one link, and l=0 if there are no links in the email. The parameter a=1 if there is a word from U or a mention of money in the sentence containing v, otherwise a=0. Money is included for illustrative purposes since phishers often lure targets by promising them a sum of money if they complete a survey or by stating that someone tried to withdraw a sum of money from the user's bank account recently, etc. The parameter L is the level of the verb, where level of a verb in SV is one more than the least number of hyponymy links followed to reach the verb from a synset in Synset (V).

The reason for weighting the link score of the email (l) and the urgency or incentive score (a) of the sentence with a directive to take action (x) with respect to a link is to reduce the false positives for emails that acknowledge some previous action of the user. For emails received by user A that are replies to emails sent by, and contain a link in either A's signature included in the reply, or in the signature of the sender of the reply. For example, when someone submits a proposal or report to a website, an automatic acknowledgment is sent by the website and it usually includes a link. There are several instances in which emails contain links in the signature fields. The reason for the exponential decay with L is the diversity of verbs and the proliferation of their different senses at greater distances from SV, which leads to an increase in the imprecision of word sense disambiguation. Even without this complexity, word sense disambiguation is a challenging problem due to the ambiguity inherent in natural languages. The Textscore of an

email e is given by Textscore (e)=Max{score (v)|vεe}.

Many different scoring functions may be utilized for verbs and for Textscore. For example, sum may be used instead of max.

Phish-Sem™ (a trademark of the University of Houston): Semantic feature selection towards automatic phishing email detection

Another embodiment of the text based classifier employs a semantic feature selection method based on the statistical t-test and WordNet®, and shows its effectiveness on phishing email detection by designing classifiers based on the text in the email combining semantics and statistics.

The feature selection method is general and useful for other applications involving text-based analysis as well. Due to its use of semantics, it is also robust against adaptive attacks and avoids the problem of frequent retraining needed by machine learning based classifiers.

This embodiment uses the same phishing email database as used by the other classifiers mentioned above, and it also uses a database of non-phishing Enron emails (www.cs.cmu.edu/˜enron) for analysis purposes. 70% of both phishing and non-phishing emails were randomly selected for statistical analysis, hereafter called the analysis sets, and the remaining 30% were used for testing purposes. A set of 4,000 non-phishing emails obtained from the “sent mails” section of the Enron email database was used as a different dataset to test our classifiers.

This embodiment uses the same phishing email database as used by the other classifiers, and it also uses two databases of non-phishing Enron emails (www.cs.cmu.edu/˜enron) for analysis purposes.

Using the feature selection method, four variants of the classifier are designed by combining statistics and semantics using Wordneein various ways, and the results are compared to determine the best variant.

Classifier 1: Pattern Matching only—This is the most basic of the variants, and it relies only on simple pattern matching between words. Here two subclassifiers are designed, namely Action-detector and Nonsensical-detector.

Action-detector: This subclassifier builds on the idea that phishing emails tend to focus on secure or valuable properties owned by the recipient, and these emails claim that these properties have been compromised in some way. All the bigrams starting with and following the word “your” in the training set were obtained and a two-tailed t-test was performed on each bigram to determine whether they qualified as candidate features. Note that instead of bigrams the general idea of N-grams, where N≧1 is any whole number, can also be tried. For example, we tried unigrams and trigrams as well, but bigrams gave the best results.

Feature selection and justification: Based on a 2-tailed t-test and an alpha value of 0.01 (the probability of a Type I error), a bigram was chosen as a possible feature if the t-value for the bigram exceeded the critical value based on alpha and the degrees of freedom of the word. There are many possible weighting schemes for the bigrams. In one scheme, for example, the weight of each bigram b, denoted w(b), was calculated using the formula:

W(b)=(P_{b}−L_{b})/P_{b}

where
P_{b}=percentage of phishing emails that contain b
L_{b}=percentage of legitimate emails that contain b

Features that had weights less than 0 were discarded as these features were significant for legitimate emails. The remaining features have weights in the interval [0,1], where features with higher weights allow better detection rate per phishing email encountered. For example, the denominator in the weight formula prioritizes a feature that is present in 20% phishing and 1% non-phishing emails over a feature that is present in 80% phishing and 61% legitimate emails.

Next, a frequency distribution of the selected bigrams was computed using their weights, and the bigrams that had weights greater than m−s, where m is the mean bigram weight, and s is the standard deviation of the distribution of bigram weights, were selected. The resulting set is called PROPERTY, as it lists the possible set of user's properties, which the phisher tends to declare as compromised.

The next task is to detect the pattern that calls for an action to restore security of the property. For this purpose, the text and links in the email were checked to determine whether there was a word that indicated the user to click on the links. First, statistics of all the words in sentences having a hyperlink or any word from the set {url,link,website}, or s of these words such as plurals, capitalization, or created by hyphenation (e.g. web-site), or created by a space after web (e.g. web site), etc., was computed. Here the same feature selection method, as mentioned above for bigrams, was employed to choose the features. The resulting set of words is called ACTION, which represents the intent of the phisher to elicit an action from the user.

Design of the Action-detector subclassifier: For each email encountered, if the email has: the word “your”, or its variants such as yours, your's, etc., followed by a bigram belonging to PROPERTY (e.g. “your paypal account”), and a word from ACTION in a sentence containing a hyperlink or any word from {url, link, website}, or variants of these words as mentioned in Paragraph [00111], (e.g. “click the link”), the email is marked as phishing.

Nonsensical-detector: If Action-detector fails to mark any email as phishing, control passes to the Nonsensical-detector. Many phishing emails escaped detection by Action-detector involved dumping words and links into the text, making the text totally Irrelevant to the email's subject. The purpose of the Nonsensical-detector subclassifier is to detect emails where: the body text is not “similar” to the subject, and the email has at least one link.

An email body text is “similar” to its subject if all of the words in the subject (excluding stopwords) are present in the email's text.

In order to achieve this, first the stopwords were removed from the subject and the t-test was applied on the remaining words to select features from the subject. The goal is to filter words that imply an awareness, action or urgency, which are common in subjects of phishing emails. The resulting set was called PH-SUB. The Nonsensical-detector subclassifier is designed as follows: for each email encountered, if the email subject has at least:
a named-entity, or
a word from PH-SUB,
   then:
if the email contains at least one link, and
the email's text is “not similar” to the subject, the email is marked as phishing.

This detector requires a named-entity in the subject since the body of the email is completely tangential and irrelevant. Thus the phisher is relying on the subject of the email to scare the user into taking action with respect to some property of the user, which implies the presence of a named entity in the subject. Thus, it is assumed that in emails of this nature with irrelevant information in the body of the email, the named-entity in the subject is the property of the user under threat (e.g. “KeyBank”, when the subject is: “KeyBank security”).

Classifier 2 (Pattern Matching+POS tagging): This classifier builds on Classifier 1, and part-of-speech tags for words are included in the t-test in an attempt to reduce the error in classification that occurs when simple pattern matching techniques are used. When the two bigrams: the first starting with the word “your” or its variants, and the second following the word “your” or its variants, are extracted, an additional check is performed to discard bigrams that do not contain a noun or a named-entity since the user's property, that the phisher tends to focus on, has to be a noun. When statistical analysis is performed on the words in sentences having a link, the words that are not marked as verbs are discarded since the feature here indicates the user to click on the link, and this word has to be a verb as it represents the action from the user's part. For the Nonsensical-detector, only named-entities, nouns, verbs, adverbs and adjectives are used when selecting features for PH-SUB. Furthermore, for the similarity check, only named-entities and nouns from the subject are selected, and their presence in the email's text are checked.

It is expected that the use of appropriate POS tags in Classifier 2 will bring an improvement in accuracy over Classifier 1. For instance, among the patterns “press the link below” and “here is the website of the printing press”, the presence of the word “press” in the former is important, but Classifier 1 sees both the occurrences of “press” as belonging to ACTION.

Classifier 3: (PM+POS+Word Senses)—Here, Classifier 2 is extended by extracting the senses of words using SenseLearner and taking advantage of these senses towards better classification. The goal is to reduce errors that result from ambiguity in the meaning of polysemous keywords. For instance, when “your account” appears, the classifier should be only interested in financial accounts and not in someone's account of an event. Toward this end, statistical analysis on words is performed taking account of their POS tags and senses, to train the classifier. Then this classifier is designed to look for patterns that match selected features up to their senses whenever the classifier analyzes an email.

Classifier 4: (PM+POS+Word Senses+WordNet®)—So far the statistical analysis has selected a certain set of features biased to the analysis dataset. This is very similar to the way training works in machine learning based classifiers. A better way to extend the features and improve the robustness and generalization capability of the feature selection method is to find words closely associated with them so that similar patterns can be obtained. To this end, WordNet® is incorporated in this classifier. Classifier 4 extends the sets PROPERTY, ACTION and PH-SUB into ext-PROPERTY, ext-ACTION and ext-PH-SUB respectively by computing first the synonyms and then direct hyponyms of all synonyms of each selected feature (with its POS tag and sense), expanding the corresponding sets. Note that because PROPERTY contains bigrams, only the nouns in these bigrams are extracted, their synonyms are added to ext-PH-SUB along with the direct hyponyms of all these synonyms. In addition, the classifier is modified as follows:

When searching for properties, a check is performed to determine whether the bigram that follows the word “your” includes a noun that belongs to ext-PROPERTY, instead of looking for the occurrence of the whole bigram in ext-PROPERTY.

In order to detect actions, each sentence that indicates the presence of a link is checked for the occurrence of a verb from ext-ACTION.

When performing the check for “similarity”, for each noun in the email's subject, the email's text is scanned for the presence of a hyponym or a synonym of the noun.

The results show that each variant of Phish-Sem™ achieves at least 92% phishing email detection with less than 5% false positives. Furthermore, classifier 4 performs best in detecting phishing and non-phishing emails correctly, obtaining a phishing email detection of 95.02% and false positive of 2.24%.

What is claimed:

1) A comprehensive method for protecting against phishing attacks, implemented on a computer, comprising: receiving a message, wherein the message includes at least one link; separating the message into its components including, but not limited to, a link part, and the text of the message; and determining whether the message is a phishing attack after processing the links and the text.

2) The phishing detection method of claim 1, wherein if the message is an email, then html decoding of the email when necessary, parsing the email into a header part, a link part, and a body which is the sender's message; determining whether the email is phishing after processing the header, the links, and the body.

3) The phishing email detection method of claim 2, wherein the legitimacy of the sender's text is verified using natural language processing techniques and uses any combination of email text syntax, text statistics, and text semantics.

4) The phishing email detection method of claim 3, wherein feature selection techniques are used to enhance the text based classification to detect phishing emails.

5) The phishing email detection method of claim 4, wherein pattern matching is used to group candidate features from the email's text and statistical tests are performed on these features to select the combination of features used in phishing email detection.

6) The phishing email detection method of claim 5, wherein the email's subject is analyzed to aid in the detection of phishing.

7) The phishing email detection method of claim 6, wherein along with the pattern matching, the part-of-speech tags for each word in the email message are used to group features.

8) The phishing email detection method of claim 7, wherein along with the pattern matching and part-of-speech tags, the sense of each word is included in the grouping of features.

9) The phishing email detection method of claim 8, wherein along with pattern matching, part-of-speech tags and word senses, WordNet® is incorporated to expand the set of selected features to further enhance phishing email detection.

10) The phishing email detection method of claim 3, wherein a distinction is made between emails that demand some action from the recipient (“actionable” emails) versus emails that do not require any action (“informational” or “descriptive” emails).

11) The phishing email detection method of claim 3, wherein:
a database called a “context history” is maintained which stores the label (phishing or non-phishing) of each received email, which can also be used to decide whether any new received email is a phishing attempt using any similarity detection technique, for example term frequency-inverse document frequency, between the email to be classified and emails in the database;
the user is allowed to manually take control of deciding: whether the email is a phishing attempt, how much and which emails to use for the context database and then updating the context history.

12) The phishing email detection method of claim 3, wherein the email is intercepted before it reaches the mail user agent of the receiver.

13) The phishing email detection method of claim 3, wherein the email's path of delivery is traced using the header and then compared to the sender information visible to the receiver's mail user agent to determine whether the email is phishing.

14) The phishing email detection method of claim 3, wherein the links in the email are verified, without even traversing them, using web search, which is based on selecting keywords from the email text along with information from the links in the email, and public phishing blacklists.
